(19) United States
(12) Patent Application Publication
(10) Pub. No.: US 2025/0245767 A1
(43) Pub. Date: Jul. 31, 2025

(54) AERIAL FIREFIGHTING PLANNING, CONTROL, AND ASSESSMENT

(71) Applicant: Trident Sensing, Inc., Colorado Springs, CO (US)

(72) Inventors: Stephen J. Pollard, Oakley, UT (US); Colin M. Pollard, Salt Lake City, UT (US); Lukas R. Majors, Draper, UT (US)

(73) Assignee: Trident Sensing, Inc., Colorado Springs, CO (US)

(21) Appl. No.: 19/041,878

(22) Filed: Jan. 30, 2025

Related U.S. Application Data
(60) Provisional application No. 63/626,792, filed on Jan. 30, 2024.

(51) Int. Cl. G06Q 50/26; G06Q 10/0631

(52) U.S. Cl. CPC G06Q 50/265; G06Q 10/06313

(57) ABSTRACT

A system for control of a firefighting operation including a ground control center with a command terminal for managing assets that include manned and unmanned aerial vehicles, a communications network, a mission planning software application, and a command-and-control software application. The ground control station may include secondary terminals for managing larger operations. The software applications produce displays that are oriented to a common rasterized map display. A computer-implemented method for planning a firefighting operation comprising determining a mission objective, assessing a mission environment, designing a route to accomplish the objective, deconflicting the new mission from planned missions, and adding the new mission to an operational plan. A computer-implemented method of assessing a mission comprising determining whether a mission was executed according to plan, determining whether an actual retardant drop footprint matches the planned footprint, and determining whether the actual footprint achieved the mission objective.

### CROSS-REFERENCE TO RELATED APPLICATIONS

This application claims priority to U.S. Provisional Patent Application No. 63/626,792, filed Jan. 30, 2024, and has specification that builds upon U.S. patent application Ser. No. 18/949,239, filed Nov. 15, 2024, both of which are hereby incorporated herein in their entirety.

### BACKGROUND OF THE INVENTION

### Field of the Invention

Embodiments of the disclosed invention relate to systems and methods for ground-based planning, control, and assessment of aerial firefighting operations.

### Relevant Background

Existing methods of planning and coordinating aerial firefighting are generally ad hoc and heavily dependent on voice instructions relayed to participating aircraft from an airborne aerial supervisor or lead plane aircraft. Aerial firefighting is an extremely hazardous aviation environment. Instead of using radar-based air traffic control, such flights are generally flown during the day under visual flight rule (VFR) conditions. As a result, mission tracking and deconfliction are accomplished by radio reports, visual clearing, and establishment of altitude blocks in the operational area by participating pilots. While visual deconfliction is effective in ideal conditions, visibility during firefighting operations may be limited by weather or obstructed by smoke. Added to this, dangerous columns of superheated air may rise up from the ground to flight altitudes, further complicating the deconfliction task. As a result of these challenges, the deconfliction of assets is inefficient, since each asset is assigned its own dedicated altitude block.

What is more, aerial firefighting missions involve the precision, low altitude dispersal of fire retardants, which present unique challenges for aircrews. Such challenges include descent to a very low drop altitude, release of retardant, and a climb to a safe transit altitude. Flight at drop altitudes and the climb back to safe transit altitude involves avoidance of terrain and obstacles. In particular, an aircraft's climbing capability, and hence obstacle avoidance, is greatly affected by the amount of fire retardant carried, whether or not and when the fire retardant is dropped, density altitude, and winds. The execution of retardant drop maneuvers is currently entrusted to the pilot's ability to navigate visually in daylight conditions to an approximate drop location, visually avoid obstacles, and execute a safe climb out.

On top of these challenges, accurate dispersal of retardant is difficult, and even when a retardant drop is well-executed, no one typically performs an assessment of the drop's effectiveness for controlling the fire. Both the execution of a planned drop and the drop's effectiveness have follow-on effects for subsequent retardant drop mission scheduling.

Because of these substantial challenges, current methods of aerial firefighting planning and control are inefficient, restricted to day VFR conditions, and do little to mitigate the already hazardous aviation environment such firefighting involves. Further, there is currently little or no means of assessing the results of a retardant drop, and therefore no means to improve subsequent mission planning through pilot debrief and asset allocation using such assessments.

It is thus surprising that no better method of aerial firefighting planning and control currently exists. Despite such real-world absence, various proposed means for improved aerial firefighting do exist. For example, U.S. Pat. No. 11,573,578 B2 by Zilberstein, et al. (Zilberstein) discloses a system and method for retardant dispersion using a swarm of unpowered UAVs. However, the system relies solely on unmanned aircraft and consequently does not contemplate elements that are relevant to pilots flying the dispersion missions, such as the use of a HUD or an asset-tailored rasterized map display that is coordinated with mission planning and command functions. Zilberstein discusses straight-line air route segments for retardant drop planning and allocates retardant drop rates by segment. By contrast, the present invention orients retardant drop paths or footprints to a rasterized map, so that drop routes may be planned to cover selected pixels of ground area. Further, the disclosed invention allows pixel-by-pixel coverage allotment that can be adjusted based on nearby fire intensity, ground fuel levels, or geographic features. Zilberstein does disclose post-retardant drop assessment of effectiveness, including conducting imaging passes to observe the effects of a retardant drop. However, the present invention systematically compares the actual drop route as flown to the planned drop route and uses ballistic modeling to estimate a pixel-by-pixel drop footprint based on the flown route. In addition, disclosed display software allows visual comparison of anticipated drop effects on the fire to actual observed effects as imaged by post-drop assessment missions.

Another proposed firefighting system, U.S. Publication No. 2010/0036549 A1 by Kwan, et al. (Kwan), discloses systems and methods for predicting a distribution of retardant when dropped from an aircraft. Kwan uses a waypoint-based retardant drop run to be executed by an aircraft but does not discuss altitude change requirements during the drop run and does not include the use of a HUD display to direct the drop run or a rasterized map display to coordinate with planning and command functions. In addition, like Zilberstein, Kwan does not orient its retardant drop runs to individual geographic areas and does not perform ballistic modeling to predict drop locations or footprint. Further, Kwan does not disclose post dispersion assessment of the actual drop, the drop's effectiveness against the fire, or the related improvement of subsequent firefighting planning. U.S. Pat. No. 10,046,187 B2 by Doten (Doten) discloses a LiDAR-based system for aerial wildfire fighting. In addition to its reliance on LiDAR, Doten also does not discuss altitude variation during retardant drop runs and relies on the use of a luminescent dye to discern the retardant drop footprint. Post-drop assessment of retardant effectiveness primarily relies on reports from pilots about the effectiveness of their mission. Doten also does not include the use of a HUD to direct retardant drop runs or the use of an onboard rasterized map display.

The disclosed system therefore presents a number of advantages over current aerial firefighting operational planning and control. The system uses aircraft position monitoring, fire position monitoring, and retardant drop status that is temporally and geographically synchronized.

Command-and-control and mission planning functions are oriented to a shared rasterized map display capable of displaying pixel-by-pixel evolution of a fire, ground tracks of planned missions, as well as fuel type, moisture content, human structures, and geographic features. The shared map and overlays allow planning and command-and-control functions to plan, direct, coordinate, and deconflict flight operations in a firefighting theater.

Retardant drop planning is greatly improved by accurate fire location mapping that is oriented to individual pixels representing discrete geographical areas. Using known fire location and movement trends, as well as sophisticated ballistic models and wind corrections, precise retardant drop paths are determined, ballistic models update the retardant drop as it is accomplished, and drop locations are simulated and recorded. Such use of ballistic modeling, a technology typically used for military ordinance targeting, is unknown in the field. By comprehensively planning the retardant drop maneuver, aircraft execution of the retardant drops can be flown manually or on autopilot and become suitable for execution by unmanned aerial systems (UAS). Further, a particular aircraft's ability to execute a planned retardant drop and safely climb back to altitude while avoiding obstacles can be calculated beforehand for various retardant loads.

During operations, participating aircraft can be deconflicted, precision retardant drops can be accomplished and documented, and before and after imagery can be used to assess the drop's effectiveness—all while monitoring the fire location and movement. Finally, because precise and known flight paths are flown by assets, less dedicated airspace can be allocated to each asset. Together, these capabilities allow aerial firefighting operations to be flown more safely and more efficiently.

Another substantial advantage of the disclosed system is that it opens aerial firefighting operations to nighttime. Where day VFR aerial firefighting is dangerous, night operations are prohibitively risky. Visibility at night is limited, and therefore deconfliction and assessment of retardant drop effectiveness become nearly impossible. By allowing the use of uncrewed aircraft, the establishment of planned missions that can be flown on autopilot, and effective aircraft deconfliction, aerial firefighting operations can be conducted more safely at night. Nighttime operations are advantageous for firefighting because the lower heat, higher humidity, and calmer wind conditions typically render flame retardants more effective in fighting wildfires.

It is apparent that what is needed is a system and method for aerial firefighting planning, control, and assessment that is adapted for use by manned and unmanned aircraft, that is capable of planning drop routes for deploying flame retardants and other aerial firefighting missions, that is able to control and coordinate aerial firefighting efforts in a given area, that allows for use of autopilot for aerial missions, and that allows safe nighttime aerial firefighting operations. These and many other deficiencies of the prior art are addressed by one or more embodiments of the disclosed invention. Additional advantages and novel features of this invention shall be set forth in part in the description that follows, and in part will become apparent to those skilled in the art upon examination of the following specification or may be learned by the practice of the invention.

### BRIEF DESCRIPTION OF THE DRAWINGS

Features and objects of the disclosed invention and the manner of attaining them will become more apparent, and the invention itself will be best understood, by reference to the following description of one or more embodiments taken in conjunction with the accompanying drawings attached following this description.

FIG. 1 depicts exemplary elements of a firefighting system as used in embodiments of the disclosed invention.

FIG. 2 depicts exemplary elements of a firefighting system as used in embodiments of the disclosed invention.

FIG. 3 depicts exemplary elements of a firefighting system as used in embodiments of the disclosed invention.

FIG. 4 depicts a block diagram of at least a portion of a mission planning application as used in embodiments of the disclosed invention.

FIG. 5 depicts an exemplary mission planning graphical user interface (GUI) as used in embodiments of the disclosed invention.

FIG. 6 depicts a flow chart of at least a portion of a mission planning procedure as used in embodiments of the disclosed invention.

FIG. 7 depicts a block diagram of at least a portion of a command-and-control application as used in embodiments of the disclosed invention.

FIG. 8 depicts an exemplary command-and-control GUI as used in embodiments of the disclosed invention.

FIG. 9 depicts a flow chart of at least a portion of a post-retardant-drop assessment procedure as used in embodiments of the disclosed invention.

FIG. 10 depicts an exemplary heads up display as used in embodiments of the disclosed invention.

FIG. 11 depicts an exemplary heads up display as used in embodiments of the disclosed invention.

FIG. 12 depicts a block diagram of an exemplary computing device as used in embodiments of the disclosed invention.

The Figures depict embodiments of the disclosed invention for purposes of illustration only. One skilled in the art will readily recognize from the following discussion that alternative embodiments of the structures and methods illustrated herein may be employed without departing from the principles of the invention described herein.

### DEFINITIONS

Software application, application, or app means a computer program intended for use by an end user. Apps may be hosted on a remote server and accessed through a web browser or may be hosted locally.

Unmanned aerial systems (UAS) means an aircraft capable of operation without an on-board human operator. UAS may be fully autonomous or remotely piloted.

Continuously Computed Release Point (CCRP) modeling or ballistic modeling means a method of determining a precise target line, altitude, and timing for a retardant drop by calculating the location of ground impact for a load of fire retardant based on: the flight characteristics of the retardant material, the asset location, the asset movement, wind speed and direction, altitude, humidity, air buoyancy and other relevant factors.

A fire or flame retardant is a substance dropped from an aircraft for aerial firefighting. It may be dropped at the edges of a wildfire to contain its spread and allow ground crews time to contain the fire. Fire retardant may also be dropped directly onto the fire to cool the fire and reduce flame size. Fire retardant formulations include water or water mixed with thickening agents such as borates, or ammonium phosphates, and dyes to improve visibility. Fire retardants may also be gel based.

### DETAILED DESCRIPTION

The invention described herein are systems and methods for aerial firefighting operational planning, control, and assessment that allow operations to be automated and to be conducted at night by manned or unmanned aircraft. Use of a common rasterized map display allows missions to be planned, directed, executed, and assessed in a way that is temporally and geographically synchronized across the operational domain.

Embodiments of the disclosed invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the disclosed invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings but are merely used by the inventor to enable a clear and consistent understanding of the invention. Accordingly, it should be apparent to those skilled in the art that the following description of exemplary embodiments of the disclosed invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

### System Infrastructure

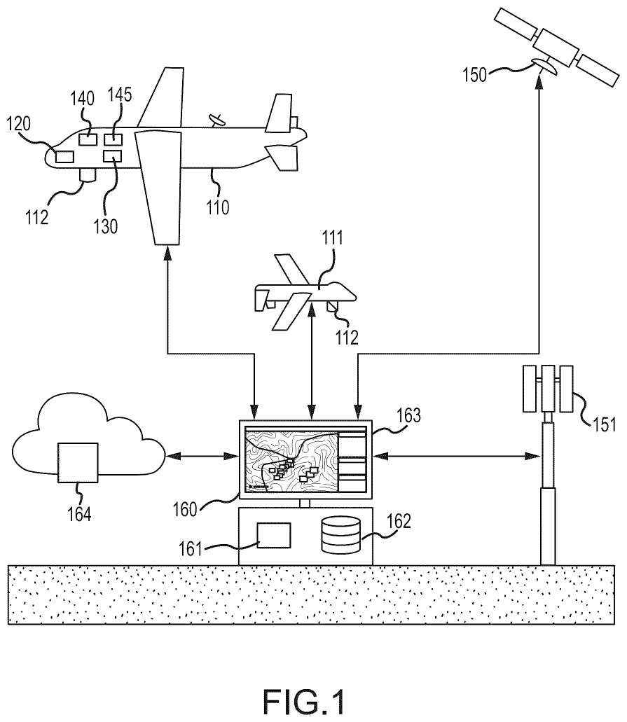

With reference to FIG. 1, infrastructure for use in embodiments of the disclosed invention is depicted. Manned 110 and unmanned 111 airborne assets that participate in firefighting operations are ideally fitted with infrared mapping sensors 112. The mapping sensor includes one or more long wave infrared (LWIR) camera(s) configured to provide multidirectional coverage of areas below the aircraft. Other suitable infrared or thermal imaging sensors may be used. Images acquired by the mapping sensor are time and location stamped and passed to specialized software applications. Aircraft 110, 111 are also equipped with satellite and cellular networking devices 120, such as a SkyLink™ terminal that connects to the Iridium Certus™ satellite network 150 and/or a cellular network 151, such as a 5G network. Other suitable satellite terminals and networks may be used. Satellite networking allows voice and data communications between participating aircraft and the ground control station 160. Precise aircraft location can be supplied by Global Positioning System (GPS) terminal, an inertial guidance system, or combination device 130. Aircraft location information is used to characterize mapping sensor data, and to allow monitoring by the ground station 160. Aircraft are also equipped with a heads-up display (HUD) 140, such as the Epic Optix Eagle™ heads-up display, or a heads-down display (HDD). The HUD or HDD is driven by a guidance and display generation device 145, such as a Garmin GMC-605™ Together, HUD/HDD and the guidance and display generator 145 are used by a navigation control system (NCS) to display visual guidance for retardant drops, fire mapping missions, and other firefighting missions. Other onboard display systems may also be used to provide coordinated operational guidance.

The ground control station 160 includes a mobile command processor 161, a database 162, and a command terminal 163. The ground control station may be a mobile device such as a laptop or notebook computer or may include more substantial computing assets rendered mobile by mounting in a specialized command-and-control or communications vehicle. The ground control station 160 is connected to the internet through one or more network systems, to include the satellite 150 and cellular networks 151 available to the participating aircraft, or other suitable network connectivity resources, such as instant messaging systems, mesh networks, near-field communication devices, two-way radios, software-defined radios, etc. The control station is configured to run a web-based software application, namely a command-and-control (CNC) application which generates an Aerial Supervisor Display or Air-to-Ground Supervisor Display (ATGS), as well as a mission planning (MP) software application for performing mission planning. Web-based applications are used on the ground interface with compatible applications used by firefighting assets, including ground vehicles and aircraft. Asset software applications are time-synchronized with the CNC and MP applications and use a rasterized map display for coordination. Asset software systems may be web-based or hosted on onboard equipment. Preferably, the asset software apps are versions of the CNC App having reduced permissions, and a limited ATGS map view showing only the asset's planned area of operation, or limited to a radius around the asset, etc. The control station may access additional computing resources 164, such as cloud computing servers and other resources through the network. Such back-end computing resources provide the command station with the capability to perform intensive processing, support the creation and display of a digital elevation model of terrain in the firefighting area, support aircraft deconfliction tracking, and supply processing for the creation and transmission of mission data files.

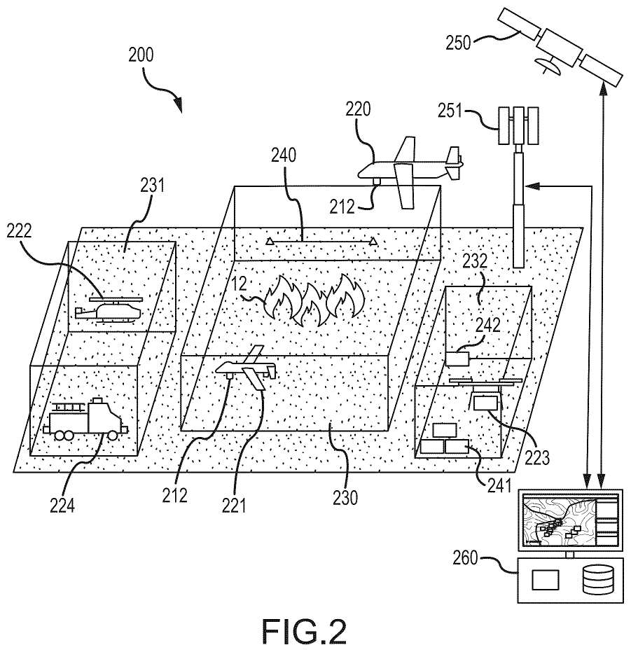

With reference to FIG. 2 is depicted an example aerial firefighting domain 200 showing assets, activities, containers, and lines of communications as used in embodiments of the disclosed invention. A domain includes the geographic area containing a wildfire 12, operational bases, and the corresponding airspace above. The assets used in the domain may include retardant delivery aircraft, i.e., tankers 220, persistent surveillance aircraft 221, search and rescue (SAR) aircraft 222, resupply aircraft 223, and tracking vehicles 224. Typically, the tankers 220 and persistent surveillance assets 221 will be equipped with fire mapping sensors 212. Dedicated fire mapping missions are planned and flown by surveillance assets 221 to characterize the wildfire and its evolution over time. Tanker assets 220 may be tasked to conduct opportunistic fire mapping whenever they are active in the domain.

In some embodiments, the domain 200 is segmented into containers for airspace control, to include a primary container 230, a SAR container 231, and a resupply/cargo container 232. For example, a primary container 230 may be established in the vicinity of the wildfire 12, while a SAR container 231 may be established near the last known location of a lost firefighter or other firefighting asset. Container boundaries are established to include a geographic area required for the task and extend up to an altitude suitable for the task, e.g., SAR asset operation may require clearance to 1000 feet (ft) above the ground (AGL), while primary asset operation may require clearance up to 3000 ft AGL. Only appropriate assets and activities would be planned for and allowed to be executed in a particular container type.

Airspace containers represent a simplified scheme for mission planning and traffic deconfliction wherein assets are routed to an airspace container based on their mission, the asset executes its mission within the container, then exits the container to return to base. Deconfliction is simplified to ensuring appropriate assets transition to and from the appropriate container at the assigned time and altitude, ensuring assets operate in their assigned containers, and ensuring other assets remain clear during transitions. Visual and/or audible alert signals are generated on the ATGS when an aircraft approaches an unauthorized container, or when an aircraft strays outside its assigned airspace container. Coordinated alerts also appear on the map displays of the assets affected by the straying aircraft.

For example, the primary container 230 is established in the area near the fire 12 and extends as required for firefighting. Only primary assets 220, 221 are allowed to operate in the primary container. Tanker aircraft 220 are tasked to fly planned retardant drop routes 240, as well as opportunistic sensing for fire mapping. Surveillance assets 221 may be deployed to fly planned sensing routes for fire mapping, such as periodic mapping to track fire evolution, or effectiveness assessments after retardant drops. The SAR container 231 is situated as appropriate to locate a firefighting asset in distress, and only SAR assets 222, 224 are allowed in the SAR container 231. In some cases, a SAR container may overlap with a primary container, and in such cases, the SAR container will take precedence over primary assets, e.g., primary assets will be excluded from portions of the primary container overlapped by the SAR container. A resupply container 232 may be set up between a supply depot 240 and a group of deployed firefighters 241. Resupply assets 223 may include cargo UAS or other transport vehicles, so the airspace above may extend up as appropriate for cargo asset operations, e.g., 500 ft AGL.

The ground control station 260 communicates with domain assets through satellite communication (satcom) 250 and cellular networks 251. Where an asset is in line of sight with a cellular tower or other cellular transceiver, they may communicate primarily through the cellular network to reduce the traffic carried on the satcom network. The satcom network is the primary network for command-and-control, and most communications involving mission tasking, mission tracking and reporting, deconfliction, retardant drops, and fire mapping will be accomplished on the satcom network. In general, however, communication is conducted over the available technology as is prudent operationally, whether satcom, cellular, messaging, radio, or other available means.

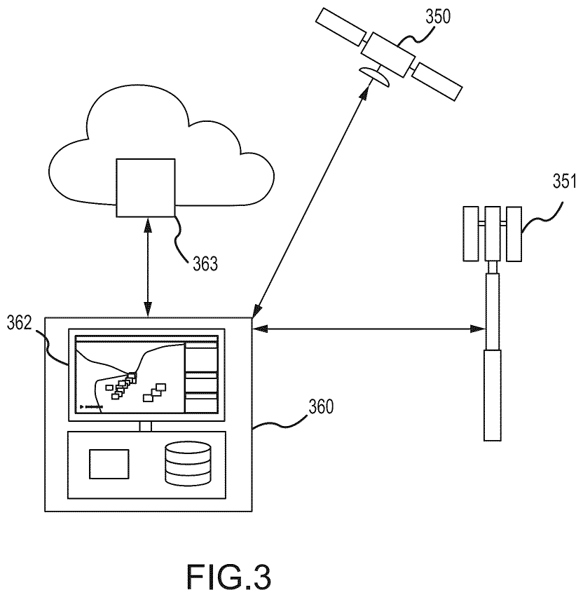

With reference to FIG. 3 is depicted the ground control station 360 referenced in FIG. 2. The ground station 360 includes at least one command terminal 362, and in some embodiments, access to cloud computing resources 363. Additional command terminals (not shown) may be made available to delegate authority to other users. For example, a situational awareness (SA) terminal may be provided for an emergency manager, a mission planning terminal for a mission planner, a, primary terminal for the retardant drop and mapping functions, a SAR terminal for a search and rescue function, etc. The ground control station 360 communicates with domain assets primarily through satcom 350 and cellular networks 351.

The command terminal 362 runs software applications, including a command-and-control application and a mission planning application. When additional personnel are available, or if the size of the operation warrants, various functions may be assigned to one or more secondary terminals and additional responsible users. For example, an Emergency Manager having overall authority for the domain may have an SA terminal that runs a version of the CNC application with a limited suite of features suitable for that function. Similarly, a mission planner may have access to the MP App only, or a SAR manager may have limited features of the CNC App useful for monitoring and managing SAR operations. The command terminal and any secondary terminal participating in the ground control station may have access to the cloud computing resources 363 to supplement processing capabilities. Tasks that may be offboarded to cloud computing assets include retardant drop mission planning, mission dispatch, mission monitoring, airspace management, aerial conflict management, digital elevation modeling, weather monitoring, ground fuels monitoring maps, predictive fire evolution monitoring, smoke plume estimation, and air and land asset tracking.

### Mission Planning Function

### Mission Planning Application

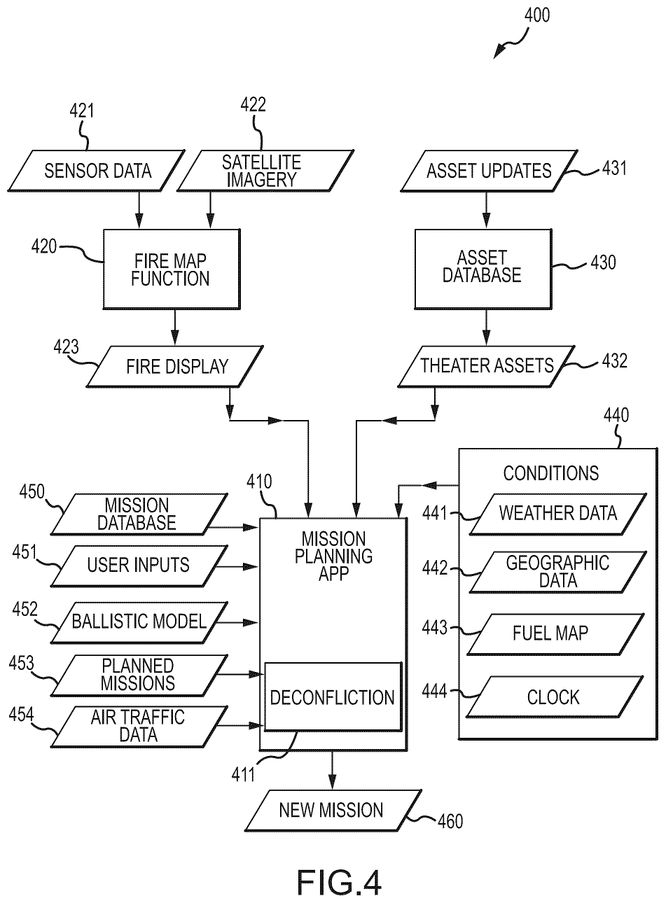

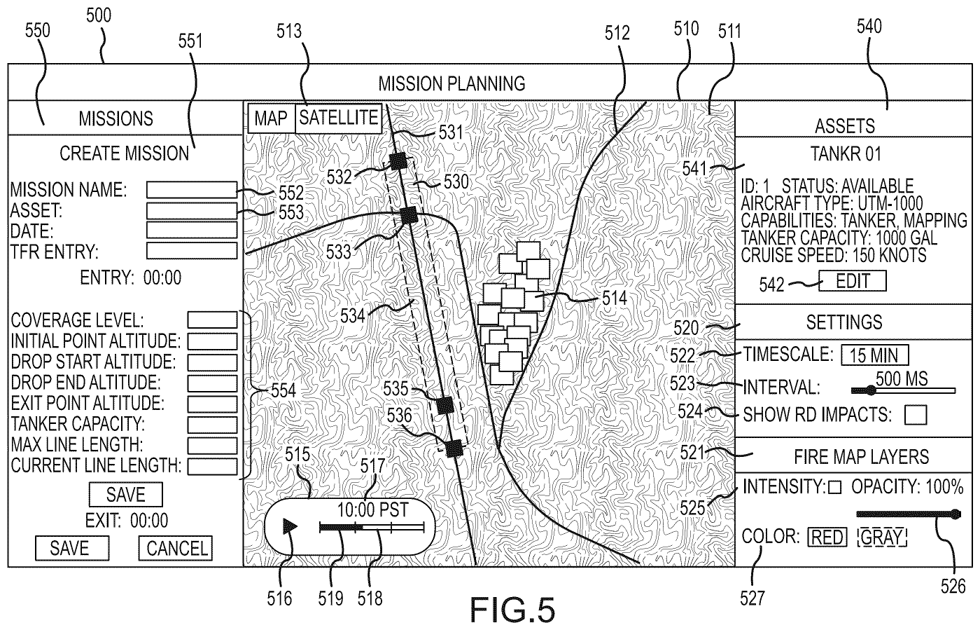

With reference to FIG. 4 is depicted a block diagram 400 of the mission planning software application inputs and outputs as used in embodiments of the disclosed invention. The mission planning app 410 is designed to be a flexible and intuitive tool to allow a user to plan the various missions required for aerial firefighting. Inputs to the MP App include outputs of a fire mapping application 420, such as is described in U.S. patent application Ser. No. 18/949,239. The fire mapping application receives sensor data 421, such as infrared or thermal imagery data of selected geographic areas from various sensor platforms that include aircraft performing opportunistic or dedicated fire mapping missions, as described above with respect to FIG. 2, items 220, 221. The fire mapping application also receives satellite data 422, including thermal or infrared imagery of fire areas, and terrain imagery of selected geographic areas. The fire mapping application outputs the fire display 423, as described below with respect to FIG. 5, item 514. The fire display 423 is provided to the MP application for use in directing resources for firefighting purposes. Further, the fire display is periodically updated to provide near-real-time information about the evolution of the fire.

The MP App 410 also receives inputs regarding assets from an asset database 430. The asset database includes an asset library that stores information about various types of assets, for example, the database stores information about different categories of assets, such as UAS systems, tanker aircraft, SAR helicopters, tracking vehicles, etc. The database stores information about subcategories of assets, such as asset models from specific manufacturers, asset models with specific engine or avionics configurations, etc. The database may also store information about specific tail numbers or individual assets. The information stored includes performance characteristics relevant to the asset mission. For example, aircraft range, climb rates, loiter time, cargo/retardant capacity, retardant drop rates, infrared sensor capability, navigational equipment, e.g., night capability, communications range, etc.

In addition to performance characteristics, the database also stores logistical information about specific assets in-theater. Logistical information may include available/not-available status, basing location, fuel load, crew readiness, maintenance status, etc. The asset database is periodically updated with asset updates 431 that update performance or logistical information about specific assets as they change during the course of an emergency incident response. For example, a tanker may change basing locations, which will change the flight duration to reach an air drop route, a UAS may need an additional 30 minutes' charging time before becoming available to fly a mission, or a flight crew may be on crew rest for an additional hour before becoming available, etc. Performance and logistical information stored in the database about theater assets 432, as updated, is made available to the MP App as an input for planning purposes.

The MP App also receives information about in-theater conditions 440 to use for mission planning. For firefighting purposes, conditions information to characterize the domain environment may include weather data 441, such as wind speed and direction, temperature, precipitation forecasts, humidity, sunrise and sunset times, or other information useful for planning firefighting missions. Geographic data 442 is also available, and may include ground elevation, terrain characteristics, e.g., mountain ranges, rivers, manmade structure locations, e.g., roads, buildings, towns, etc. A fuel map database 443 includes information about the vegetation coverage of geographic areas in-theater, including type of vegetation, moisture level, vegetation density, etc. Finally, a central clock 444 shared across in-theater applications and assets, such as an atomic clock, quantum chip clock, GPS clock, or other time measurement device of suitable accuracy, is used to time synchronize mission planning and operations.

During mission planning, the MP App 410 also has access to a mission database 450, which includes information relevant to the various mission types that can be planned in the app. For example, the mission database may include information about air drop missions, including retardant coverage rates and retardant type, maximum coverage line length per gallon, climb out distance for a given climb rate, etc. The mission database may also include standard mission profiles that may be customized or modified by a user, such as a standard resupply mission plan. In general, standard mission plans include two basic types: a container mission plan using airspace containers, and a point-to-point mission plan using point-to-point navigation. A standard point-to-point mission plan will include navigation from a basing location to enter the theater traffic control area, from there to an initial point for the route, then navigation of the route, then navigation to an exit point for the route, then to the traffic control area exit, and then a return to base. Timing to each point is specified and controlled, as is the assigned altitude.

A standard container mission profile will include navigation during a set time window and altitude block from a basing location to an entry point for an airspace container, then free navigation of the route within the container for a set duration, then navigation during a set time window and altitude block from an exit point of the container back to base.

Also stored in the mission database 450 are the various parameters that are populated automatically or that may be modified by a user for each mission type, such as those parameters discussed below with respect to FIG. 5, item 554. User inputs 451 include the adjustment of such parameters, as well as manipulation and placement of mission routes, selection of assets, or any of the other mission creation inputs discussed below with respect to FIG. 5, item 551.

A ballistic model 452, such as a CCRP, models the trajectory or flight characteristics of a retardant type or a cargo container when dropped from an aircraft. Using the ballistic model and relevant inputs such as aircraft location and movement, drop altitude, ground elevation, wind speed and direction, and air temperature, the MP App can trace a target path or footprint for the retardant drop along the ground, and use the ballistic model to calculate a route to achieve the target path or footprint. By including the target path in the mission plan, an asset executing the drop may use CCRP to adjust the route in real time to drop the retardant in the selected location. Other mission types may benefit from their own specialized models to aid mission planning, such as field of regard modeling for mapping missions.

Finally, the MP App 410 references information to perform deconfliction 411. Such information includes previously planned mission profiles stored in a planned mission database 453. Previously planned mission data include the type of mission, planned container, planned routes, planned flight altitudes, planned timing, asset type, etc. In one aspect of the deconfliction function, the app ensures that any new missions planned will avoid becoming a traffic risk for other assets scheduled to perform missions in-theater by assessing the newly planned mission against the proper container, planned locations, altitudes, airspeeds, and trajectories of previously planned missions to ensure adequate clearances. In a second aspect of deconfliction, the app uses air traffic data 454 to check newly planned missions against traffic in-theater to ensure there are no potential conflicts. Such near-real time deconfliction may be appropriate where a mission is tasked for immediate execution, or has its existing plan modified prior to execution. Air traffic data 454 is passed from the CNC App or it may be assembled independently from available sources.

Once the route is assembled and deconflicted, the MP App outputs a new mission 460. The user can then save the new mission, which will be added to the planned mission database 453 and scheduled for execution, or the new mission can be discarded.

### Mission Planning Graphical User Interface

With reference to FIG. 5, an example mission planning graphical user interface (GUI) page (MP Display) 500 generated by the mission planning software application is depicted. The MP App may be used to plan air drop missions, fire mapping missions, SAR missions, or resupply/cargo transport missions. In some embodiments, the app includes permissions that restrict a user's access to a particular type of mission for planning, for example a user or terminal may only have access to primary missions, while another user or terminal is configured for SAR mission planning, or resupply/cargo mission planning.

A user accesses and provides inputs to the mission planning software app primarily through the MP Display pages. As shown, the MP Display 500 depicts mission planning for an air drop mission. The MP Display includes a map panel 510 for displaying a map view 511 of the domain. The map view is configured to display a rasterized, pixel-by-pixel representation of the geographic area used for operations. The map view may be a satellite imagery view showing landscape features, roads 512, vegetation (fuel), landmarks, etc., or may be an illustrated map view. Each pixel of the map represents a specific geographic subset of the area, each of which may be associated with characteristic values, including thermal values, reflectivity, fuel type, fuel moisture level, manmade structure content, etc. The satellite view or map view is alternatively selectable by clicking a view button 513. The map panel may include overlays onto the map showing the location of planned mission routes, man-made structures, utilities, weather, and other features. For example, an active fire display 514 will be overlaid onto the map showing the location and footprint of the area experiencing the wildfire.

The fire display 514 is generated by a combination of satellite imagery and infrared sensor data and shows fire location and area at specific times. The fire display is anchored to individual pixels, each of which is assigned a thermal value reflecting the presence or absence of fire, fire intensity, or burned or unburned status. As successive mapping data is gathered, a composite moving display of the fire can be developed depicting how the fire evolves over time, and capable of predicting its future evolution. The mission planning fire display, and other temporal overlays, such as weather data, ground asset tracking data, and airborne asset tracking data, are time synchronized with the CNC application as well as any asset software applications.

MP Display controls allow the mission planner to control the map display on a granular level to assist with mission planning. A display control 515 includes a play/pause button 516 to alternately advance or halt the display. In the play mode, the display shows the fire's evolution over time and may depict the footprints of planned missions, and other overlays, and includes a selectable menu of playback speeds. In the halt mode, the display can be frozen at a specific time 517, which is indicated on the control. A time scale 518 allows for additional control of the display. By manipulating the timeline bar 519, the user can select a specific time for the fire display across the range of time displayed on the time scale. For example, if the time scale is set to display the fire at times ranging from 8:00 MST to 2:00 MST, the timeline bar can be set at a specific time 517 or can be advanced through the range forward or backward in time across the available time range. In such way, a user may view fire evolution over time, its projected movement in the future, and its location at specific times down to the individual pixel level. With a planned mission layer displayed, advancing the timeline also allows the mission planner to see projected effects of retardant drop or mapping missions, and ground tracks of future planned missions, to include retardant drop footprints, and dedicated and opportunistic mapping coverage.

The system further allows granular control of the map display through a pair of panels 520, 521 with tools for adjusting the fire display 514, planned missions, and other layers. A settings panel 520 includes a timescale control 522 for adjusting the duration of imagery aggregation and repetition, and an interval control 523 to adjust the interval between individual snapshots of the operation. When selected, a Show RD Impacts box 524 causes the display to show the actual footprints or target paths of retardant drops that have been executed. A fire map layers panel 521 includes layers that may be selected by the user for display on the map, e.g., an intensity box 525 when selected adds a layer showing temperature of sections of the fire display 514. Other examples include an opacity control 526 for adjusting the opacity of the fire footprint, and a color selector 527 for specifying the color of the fire footprint. Other overlay controls providing relevant information about the fire are possible and may be added or removed depending on the preference of the user and availability of useful information. Through control of the map display, a mission planner can plan firefighting missions based on the evolution of the footprint, and can, for example, adjust the display opacity to better view underlying landmarks.

During the mission planning process, a planned point-to-point retardant drop route 530 may be overlaid onto the map 511. A point-to-point retardant drop route may include the aircraft track 531, an initial point 532, a drop start point 533, a drop area 534, a drop stop point 535, and an exit point 536. The MP Display also includes an assets panel 540. This panel includes a details section 541 for displaying details about the firefighting assets available for mission planning, including tail number, call sign, aircraft type, sensor capabilities, tanker capacity, cruise speed, location, and other relevant information. An edit button 542 allows a user to change or update information stored in the system for the displayed asset. By referencing the available firefighting assets, their capabilities, and locations, a mission planner can build drop routes, mapping missions, or other mission profiles for the available assets, or can otherwise allocate resources as needed.

The MP Display also includes a missions panel 550, which includes a mission planning section 551 for building the mission. The mission planning section includes a number of parameters that may be selected by the user. A mission type selector 552 includes a dropdown menu that includes the type of mission to be planned, e.g., retardant drop, fire mapping, resupply, search and rescue, etc. Selection of the type of mission alters the remaining selections available to the user. For example, if a retardant drop mission is selected, the asset selector 553 dropdown menu includes only those assets that are available and are equipped to perform the retardant drop mission, e.g., a manned tanker aircraft. Selectors for the mission date and time for the mission are also available. With the mission type selected, a details panel 554 is populated showing categories that are relevant to the selected mission type. Here, retardant drop mission details are displayed, and therefore detail selectors relevant to a retardant drop mission are shown. For example, the user can specify the amount of retardant coverage that is required, e.g., gallons of retardant per 100 square feet (gal/100 ft²), the aircraft altitude required at the initial point 532, the altitude required at the drop start point 533, the altitude required at the drop stop point 535, the altitude required at the exit point 536, the retardant capacity of the tasked aircraft, the maximum retardant line length for the asset and coverage level, and the retardant line length currently selected.

To build an aerial mission, in this case a point-to-point retardant drop route, the mission planner uses the information displayed on the map panel 510 and assets panel 540. From the assets panel, the mission planner can view what tankers are available to perform the drop or series of drops. Referencing the map page, the mission planner can, for example, view the fire display, track the fire's development, and look at geographic features to determine the location of the drop route 530.

Once the general drop location is determined, the mission planner can select a standard mission template from the database or use a mouse to set and drag points and segments to create a custom route to accomplish the mission. For example, the user can set a traffic control area entry point on the map, then an initial point 532 as the entry point of the drop route. Next the mission planner can set a drop start point 533, which is where the tanker will begin release of the retardant during the mission. Then, a drop stop point 535 is set, which is the point where the retardant release is stopped. The mission planner then selects an exit point 536, which is a point where the tanker exits the drop route. From there, an air traffic control area exit point is set, and finally the taker returns to base.

### Mission Planning Process

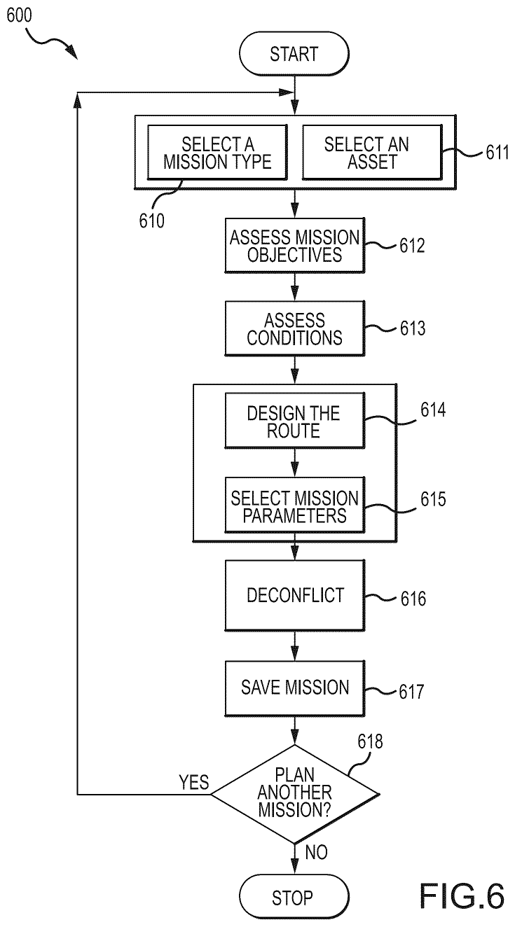

With reference to FIG. 6 is depicted a flow chart 600 representing an exemplary mission planning process through use of the mission planning app, as used in embodiments of the disclosed invention. As an initial step, the mission planner selects the type of mission 610 to be planned on the MP Display. The types of missions available include retardant drop, fire mapping, cargo/resupply, or search and rescue. In some embodiments, user permissions may be set to limit the types of missions available to a particular terminal or user. For example, a primary terminal may only have permissions to plan air drop and fire mapping missions, while a SAR terminal may only have permissions to plan air and ground search and rescue missions. With the mission type specified, the MP App accesses the mission database to populate the mission create panel of the MP Display, and to reference stored mission profiles and parameters for the selected mission type. The MP App also accesses the asset database to identify the assets in-theater that are suitable for the mission type and available for the time of the mission. The user can then select an asset 611 for mission planning from among a list of available assets, which is displayed on a dropdown menu in the create mission panel. With the asset selected, its characteristics are displayed in the MP Display assets panel. The user may alternatively select an available asset 611 first, and then select a mission type 610 from among the mission types that the asset is capable of flying.

Next, the user determines the mission objectives 612, such as a location to slow or stop progression of the fire, location to search for a trapped hiker, location of supply stores and delivery location, etc. The new mission is coordinated with the rest of the operation by comparing the new mission objectives with previously planned mission objectives, to ensure efforts of prior missions are not unnecessarily duplicated, or that multi-mission strategies are executed. Coordination performed by the MP App includes a comparison of the mission objectives, such as the planned retardant drop footprint or planned mapping area, against existing plans to determine if efforts are duplicated. Comparison settings may include limiting the existing plans to a selected time period prior to the new mission, e.g., mapping an area near the fire is not overly duplicative unless successive missions are less than 1 hour apart. Coordination performed by the user may include checking that the new mission fits within an overall plan for a retardant drop, such as laying down several drops end to end, using the timeline function to project planned mapping coverage, etc. New missions that are not sufficiently coordinated with existing missions may have their objectives or timing altered to provide a coordinated effort.

Once a general objective is determined, the user assesses the conditions 613 in theater to characterize the environment for the mission and inform the planner how best to accomplish the objective, e.g., using wind models and pixel-based fuel content to site a retardant drop. Such conditions include referencing the fire display, locating the airspace containers, and assessing the weather, geographic terrain, and fuel characteristics made available through the MP Display or otherwise through the app.

Next the user uses the map display of the MP Display to concurrently design the route 614 and set the mission parameters 615. Route construction, whether from a template, a container-type route, or a point-to-point route, should specify a sequential path that is continuous in space and time to cause the asset to ingress to the air traffic control area, to perform the mission, and then to egress the air traffic control area and return to base. The user's decision-making for route design and parameter setting may be augmented by the MP App, as discussed further below.

As the route and parameters are set, the application performs concurrent deconfliction 616 with other in-theater assets. Deconfliction is performed according to the type of mission. For a container mission, the app will check that other assets are assigned a proper distance from the asset as it travels to and from the assigned container during the prescribed time window and set altitude, then it checks that other assets are not assigned to the container during the same time window.

For a point-to-point mission, deconfliction is conducted along the route as the route is built, with the assumption that the asset will remain on its assigned route and altitude and proceed according to its set timing. The app therefore deconflicts by checking that other assets flying in their containers or executing their own point-to-point routes would maintain an acceptable distance from the asset. A margin of error is added to the route of the asset and other assets to provide additional clearance between assets. For example, using the assigned altitudes for a planned drop route, the app develops a planning volume above and below the assigned altitude that represents the vertical safety margin for the drop route. Similarly, clearance of 2000 feet on either side of the route ensures a horizontal safety margin. If the newly planned mission conflicts with an existing mission, the app may recommend a route or altitude change to avoid the conflicts, or if the new mission is a higher priority mission, an existing mission may be altered to avoid a conflict.

Once the mission is built and deconflicted, the user can save or cancel 617 the planned mission. If saved, the planned drop mission is integrated into an overall operational plan. The user may then choose to plan another mission 618, if required. Command-and-control input may order a planned mission to be altered or canceled or may order new missions to be planned. Dynamic mission planning based on command-and-control inputs is discussed in more detail below.

### Retardant Drop Planning

An exemplary retardant drop planning process follows. A mission planner using the MP Display would select an asset, and given mission objectives, would determine a general location of the drop route by examining the fire display, and considering other available information, such as in-theater conditions, previously planned drop routes, the effectiveness of a prior drop mission, or other relevant factor. The user then selects a target path or pixels of the ground to be covered with a specified retardant level. Using the target path or planned footprint, the MP App uses a CCRP model to calculate a three-dimensional (3D) trajectory estimate of the asset's air route that will accomplish the drop. The user then can set initial and exit points to transition the plane safely from its prior location to the drop route, and then from the drop route to the remainder of the asset's mission profile. Mission parameters for an air drop mission may include those displayed on the create mission panel, FIG. 5 item 554, for example, retardant coverage level, initial point altitude, tanker capacity, etc. The user sets an altitude for each point accounting for the tanker asset's climbing ability, terrain hazards, the type of retardant being dropped, the amount of retardant to be dropped, the type of retardant coverage required, or other relevant consideration. Tanker capacity required retardant coverage level, terrain, firefighting strategy, or other relevant factor may be considered to determine the length of the drop, i.e., the distance between the drop start and drop stop points. The user may also set the amount of retardant to be dropped per pixel, which is based in part using wind data and information from the fuel map database.

The MP App includes features that augment the user's route construction by providing suggestions or by limiting user inputs based on stored performance, ballistics, weather, or other relevant information. A key capability of the app is its use of the rasterized fire display. As an initial example, the MP App may use a CCRP model to assist the user in designing an air drop route. The user can trace a target drop path on the map display, using a pixel-by-pixel evaluation of the fire intensity and movement, as well as a granular assessment of fire-adjacent pixels. By evaluating the geography, fuel cover, moisture level of fire-adjacent pixels, the user can determine an optimal target line or footprint for a retardant drop. Planned drop routes may be straight-line drops, dogleg drops, or may vary by pixel. From the footprint, the application determines a projected drop route and altitude based on ballistic modelling of the retardant drop and provides suggestions for route point placement to the mission planner. The CCRP modeled route in the planning stage will be approximate based on conditions projected for the time of the drop. In execution, the actual route flown by the asset will reflect contemporaneous modeling of the target path based on actual conditions.

The mission planner may also use the map display to interactively alter route point placements, and the app uses the CCRP model to update the projected retardant footprint. In this way, the mission planner may benefit from precise modeling while having the freedom to alter drop points to better accommodate pilot preferences, aircraft performance, or other relevant consideration.

As another example, the application may develop a pixel-by-pixel minimum retardant coverage level along the drop route to effectively fight the fire. Using the rasterized fire display and conditions data overlays, the app can assess fire intensity and movement on a pixel-by-pixel basis and can assess fire-adjacent pixels based on geography, fuel type, and moisture levels. Using such information, the app develops a drop route with variable minimum coverage levels expressed in gallons per 100 square feet (gal/100 ft²). For example, the app calculates a drop route across three pixels wherein the first pixel contains a stand of dead pine trees, the second pixel contains a grassy meadow, and the third pixel contains a scrub coverage. The app would recommend a relatively high minimum coverage level for the first pixel, a lower coverage level for the second pixel, and a moderate coverage level for the third pixel. Likewise, if the fire adjacent to the second pixel were especially intense and fast moving, the app may recommend a higher minimum coverage level for the second pixel.

The app is further configured to calculate drop rates required to achieve effective coverage levels based on route conditions. For example, if a mission planner selects a 2 gal/100 ft² coverage level for a given pixel, the app uses ballistic modeling of the retardant, planned drop altitude, projected wind speed, projected air temperature, etc. to calculate the drop rate required to achieve the selected 2 gal/100 ft² coverage level. Alternatively, the recommended drop rate may be expressed as an actual coverage level, e.g., 3 gal/100 ft², required to achieve the selected 2 gal/100 ft² coverage level.

The app is also configured to calculate retardant drop rates necessary to achieve a selected coverage level, and to calculate the drop line distance based on retardant capacity and drop rates. Using asset retardant capacity and drop route airspeed, the app calculates the retardant drop rate required to achieve the selected coverage level, or alternately given a set drop rate, the app calculates the airspeed required to achieve the selected coverage level. Using the asset capacity and calculated drop rate (or alternatively, airspeed), the app calculates a maximum drop length achievable before the asset exhausts its cargo of retardant. On the map display, the app interactively informs the mission planner if the planned drop length exceeds retardant capacity. For example, the app accesses the asset retardant capacity and dynamically adjusts the width of the retardant footprint based on the planned length to ensure the planned area allows for the specified coverage level. A shorter target path would display a wider footprint and would become narrower with increasing length. Communication to the mission planner may also take the form of a text warning that appears on the GUI, proposed impossible drop points may appear in red or may flash in warning, may not be placed outside the calculated radius, or other suitable output means.

The application is also configured to ensure that the selected asset has sufficient performance to execute the planned route, e.g., it determines whether the aircraft's climb capability when loaded with fire retardant is sufficient to clear obstacles on the drop route. Using a performance model stored in the asset database, the app predicts the asset's climb rate at the planned altitude, fuel load, planned drop altitude, and terrain height on the route, for the expected weather conditions at the planned flight time. Performance on the route is assessed for various scenarios, such as if the asset successfully drops the retardant, or if the asset is forced to retain the retardant. Using the model, the app calculates whether an asset has performance to execute the proposed drop maneuver. If the asset is not capable of executing the route as planned, the app may output a warning message or may interactively guide changes to the designed route or point altitudes. For example, the app may highlight a proposed point in red until the user increases the altitude or moves the point to avoid the obstacle. The app also issues a warning if asset performance while carrying the retardant is insufficient to fly the route. In some cases, such as when an aggressive flight maneuver is required, the app may apply a more refined model to estimate performance, such as accounting for lost weight during the retardant drop, or by specifying a critical point by which the retardant drop must occur for the profile to work. In appropriate cases, the app may suggest an available asset in the database that possesses the necessary performance to fly the route, as required. The mission planner can evaluate the target line based on the altered route and decide whether to plan the route as modified or to select an asset capable of flying the original route.

As another example, the MP App may determine whether an asset is logistically capable of executing a new route being planned. During firefighting mission execution, the app receives updates to asset status. See FIG. 4, item 431. Such updates include asset availability, but also may include basing location, actual location, fuel load, retardant load, crew readiness, and other readiness information. The time required for the asset to takeoff from its basing location and fly to an initial point may affect the earliest time an asset can be on station to perform a drop. Similarly, if a tanker asset must fly a scooping profile to reload its retardant, time to travel to the water source and return to the initial point must be accounted for. In this way, the app's asset update function automates information aggregation and distribution, allowing the user to plan missions with precise mission timing and coordination.

Multiple drop routes may be built and combined into a firefighting plan that seeks to contain the wildfire, stop progression in a particular direction, protect objects on the ground, cool the fire, or other suitable objective. Drop routes can be arranged in multiple ways to accomplish the required effect. For example, drops may be arranged nose to tail, side by side, or on top of a previous drop. In this way, smaller tankers such as UAS tankers or single engine air tractors, can combine to achieve same effect as a tanker with a larger payload capacity.

Other mission types are possible and contemplated. For example, a mapping mission may be planned to use an infrared sensor-equipped asset to locate the evolving fire footprint or locate the footprint of a retardant drop. The mission planner uses the map display to determine where a mapping mission is required or recommended on a pixel-by-pixel basis. By use of the fire display with quality and staleness layers visible, the mission planner may examine the quality or staleness of fire display data, the location of the fire, the movement of the fire, projected evolution of the fire, recent accomplishment of a drop mission, changes in fire intensity, location of structures, or other relevant consideration. From such examination the mission planner selects areas to map. For example, a section of the map display with no data may be assigned a higher priority for mapping. Similarly, an area with older, low quality, or stale data may have a high priority for mapping. A pixel adjacent to a burning pixel, or in an area wherein the fire is projected to spread, would be prioritized for mapping to determine fire evolution or location. A pixel containing a retardant drop footprint may be mapped to assess the effectiveness of the retardant drop mission. Similarly, a pixel adjacent to human-built structures may be mapped more often to ensure the fire does not threaten such structures.

With the mapping route sited, the user identifies a mapping asset to accomplish the mission, and assesses factors including the asset's range, basing location, sensor sensitivity, and sensor field of regard. Using the sensor sensitivity to determine flight altitude, and the field of regard to determine the width of an imaging pass, the mission planner can use the asset range to determine the area it can cover in a given mission. The mission planner then builds a mapping route to cover the selected pixels as viewed from the planned altitude. The MP App generates a projected coverage area of the new mission that is displayed on the map view to assist the user in achieving coverage of the desired area. The app accounts for the asset's field of regard, as well as planned flight altitude and bank angle, and projected smoke or cloud cover to generate the projected coverage area for the mission. Analysis of the planned coverage area also allows the planner to order specific maneuvers to improve coverage, e.g., the mission plan may include a series of banking turns to better aim the sensor at oblique areas along the route, or the asset may be directed to perform a steep climb to achieve coverage over a ridge or tree line. Using the planned coverage depictions, the planner may plan multiple missions to cover selected areas of the operational domain.

The planner may also choose to use opportunistic mapping missions using sensors mounted on assets executing retardant drop missions. Assets flying retardant missions can opportunistically cover areas along the route of their primary mission and may be rerouted before or after the retardant drop to map a selected area. Many such missions will be able to map critical areas near the fire and in areas of intense firefighting operations. Using the retardant drop route and any mapping reroutes, the mission planner can generate a planned mapping coverage area for the mission. Opportunistic mapping coverage may then be combined with dedicated mapping coverage to map a selected area. Like the planned mapping coverage, opportunistic mapping coverage is displayed using the planned mission layer on the MP Display to facilitate planning and coordination.

The user may need to modify mapping routes and altitudes to occur within the primary container, to avoid conflicts with other missions, or to coordinate a mapping operation. The mission planner uses pixel mapping priorities, and available assets to produce a coordinated mapping operation. Given the number and capability of assets, as well as the acreage to be mapped, the planner can design an operation to ensure areas are mapped in order of their priority and can set the frequency with which certain areas are mapped. Mapping coverage is facilitated by use of the planned mission layer that may be selected for display on the map. By use of the timeline controls, mapping coverage can be visualized at future times to show what geographic areas are mapped and when. Mapping planning is necessarily dynamic, and the planner can reallocate assets and modify missions based on changes to the fire, execution of a drop mission, or priority changes communicated by the command-and-control function.

The MP App is configured to augment the decision-making of the mission planner for mapping operations similarly to ways it augments retardant drop planning. For example, the app can assess whether an available asset is capable of reaching a planned mapping route from its basing location. The app can also dynamically assist the planner in designing a route that maximizes asset range, that avoids planned loiter times that exceed the asset's range or can recommend a more capable asset to map an area that a selected asset cannot. Given a mapping footprint selected by the mission planner, the app is configured to recommend a mapping route capable of covering the selected footprint based using the asset sensor sensitivity and field of regard.

The MP App may also be used to plan a search and rescue mission to locate survivors or stranded or lost ground crew. Such missions may be planned as a point-to-point mission similar to a mapping mission, wherein the asset is routed to an entry point, then a search pattern is flown, and the asset proceeds to an exit point. A search pattern may be planned to cover a selected area, and multiple assets may be tasked to collectively cover a larger search area. Similarly, the app may be used to construct a point-to-point cargo/resupply mission similar to a retardant drop, wherein the asset starts from a basing area near a cargo depot, is directed to a cargo drop point and given a descent to a drop altitude to perform a precision wind-corrected drop of supplies, survival packages, or other cargo. With the drop complete, the asset is directed to climb to an egress altitude and exit point before returning to base. In some cases, SAR and cargo missions may involve more stationary missions or missions confined to a relatively small area. Such missions may be planned as container-based missions, wherein the asset is simply assigned to a container for a set period of time.

### Command-and-Control Function

### Command-and-Control Application

In addition to mission planning functionality, the disclosed invention also includes operational control of aerial firefighting efforts. The command-and-control app is a web-based software application configured to monitor and coordinate all missions that occur in-theater based on near real-time fire and aerial asset location and track information. Use of the CNC App allows a user to dispatch and monitor the execution of planned aerial firefighting missions, deconflict traffic operating in the domain, receive real-time feedback from missions, and assess the effectiveness of firefighting efforts.

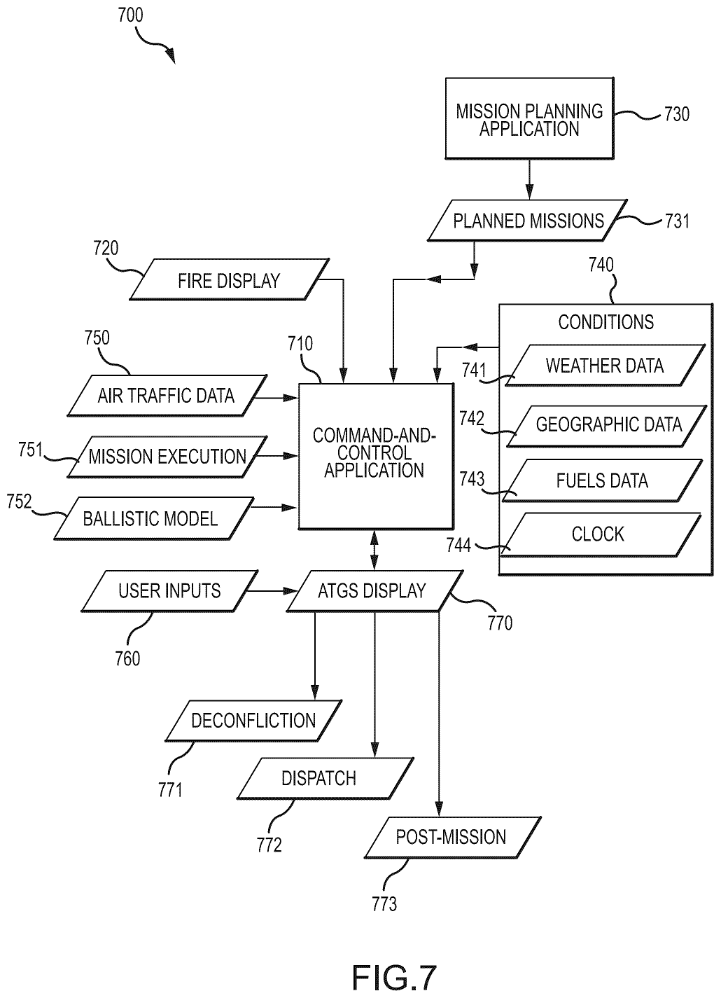

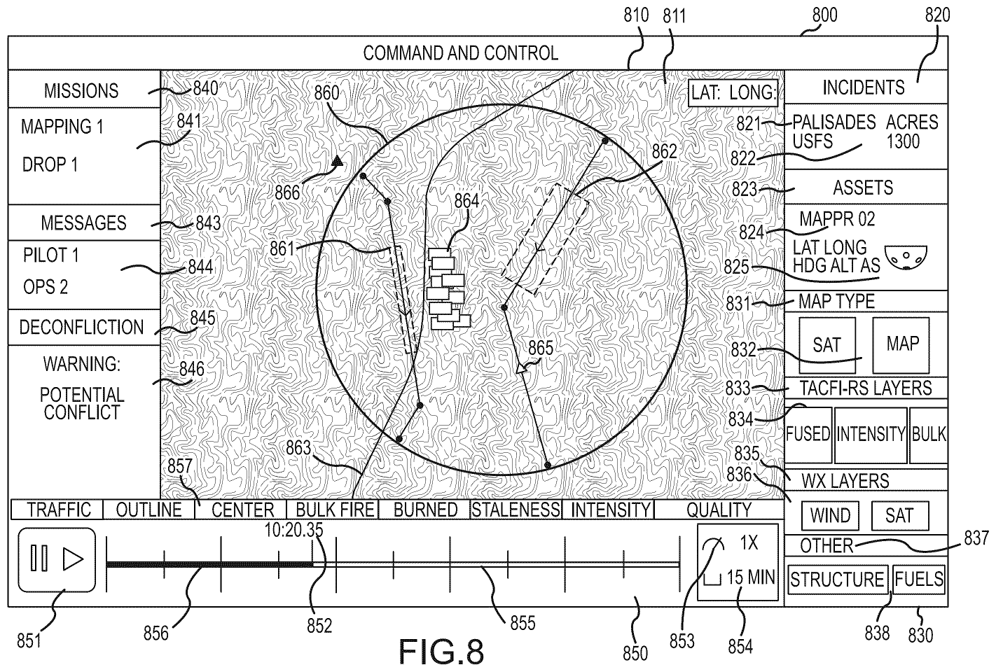

With reference to FIG. 7 is depicted a block diagram 700 of the command-and-control software application inputs and outputs as used in embodiments of the disclosed invention. The CNC App 710 receives inputs from the fire mapping application, specifically, the rasterized fire display 720, as described below with respect to FIG. 8, item 864. The fire display is provided to the CNC App for use in directing resources for firefighting purposes. The CNC App also receives input from the MP App 730, including planned mission data 731, which are used to provide a command user with awareness of planned missions at any time during operations. Planned mission data is used to generate a mission coverage layer on the display showing planned drop routes, planned retardant footprints, planned mapping coverage, etc. Information regarding planned missions can provide valuable decision-making context, such as the number and type of missions planned for a particular interval, or the number of missions planned for a particular task. Planned missions are ordered to be executed by the command-and-control user through the app. Once ordered, the mission is packaged for transmission and sent by the mission planning function to the asset via network.

The CNC App also receives information about in-theater conditions 740 for mission coordination purposes. Conditions information may include weather data 741, such as wind speed and direction, temperature, precipitation forecasts, humidity, sunrise and sunset times, or other information useful for conducting firefighting missions. Geographic data 742 is also available, and may include ground elevation, terrain characteristics, e.g., mountain ranges, rivers, manmade structure locations, e.g., roads, buildings, towns, etc. A fuel map database 743 includes information about the vegetation coverage of geographic areas in-theater, including type of vegetation, moisture level, vegetation density, etc. A central clock 744 is used to synchronize command-and-control displays with the MP App and asset app to coordinate mission planning and operations in-theater.

The CNC App also has access to air traffic data 750 for aircraft operating in-theater, such as their near-real time location, altitude, and airspeed. Air traffic data may be derived from air traffic control radar, or assembled from aircraft navigation system data, or assembled from cellular or other signal triangulation methods. Ground asset locations may also be tracked through GPS receivers or telemetry. Use of air traffic data allows a user to monitor air traffic and deconflict flight routes in near real time. The app also uses post-mission data 751, such as pilot debriefs, air traffic data, and thermal imagery in retardant drop areas to assess whether a planned mission was executed, and whether it was effective. Like the mission planning app, the CNC App has access to a CCRP ballistic model 752 to calculate the trajectory or flight characteristics of a retardant type or a cargo container when dropped from an aircraft.

Finally, the app receives user inputs 760 to facilitate mission execution. Such inputs include rerouting air assets, ordering a planned mission to be executed, delaying or canceling planned missions, ordering new missions, and other suitable command-and-control inputs. The primary means of providing user input 760 and receiving output from the CNC App is through the Air-to-Ground Supervisor Display (ATGS) graphical user interface 770. By interacting with the ATGS, the user is able to perform deconfliction of airborne assets 771, can allocate resources by dispatching missions 772, and is able to perform post-mission assessments 773 of missions to determine whether a mission has been executed and whether it was effective.

With reference to FIG. 8 is depicted an example ATGS page 800 for use in facilitating command-and-control of firefighting operations. The ATGS page includes a map panel 810 for displaying a map view 811 of the domain. The map view may be a satellite imagery view, or a street map view as selected by the user. The map view may show landscape features, roads, vegetation (fuel), landmarks, etc. The map view includes overlays showing the location of, for example, airspace containers 860, planned asset routes 861, 862, man-made structures, e.g., roads 863, utilities, weather, and other features. An active fire display 864 is also overlaid onto the map showing the location and footprint of the area experiencing the wildfire. The ATGS map view is rasterized and oriented to the same pixel-by-pixel representation as used by the MP application and asset applications, and is also time-synchronized with such apps, and therefore all operational and planning functions in-theater are coordinated, and all system functionalities are coordinated on a granular level.

Control of the map view is accomplished through a number of control panels arrayed around the map panel 810. At the upper right of the display is an incident panel 820. The incident panel identifies the particular emergency incident 821 being displayed on the map view 811. Other relevant information may also be displayed 822, such as the controlling agency, the number of acres burned, days into the incident, or other relevant information.

The CNC App receives location and track information from aerial assets participating in the operation, which will be represented by dynamic symbols on the map display. Asset symbols may be selected 865 or unselected 866 and the display will indicate selection status by color, a blinking symbol, etc. (here, the selected asset is shown with a white symbol). An assets panel 823 shows information about the selected asset 865, such as the tail number 824, and other information 825, such as location, altitude, airspeed, heading, and mission equipment, such as sensor type or tanker capacity, etc.

A map layer panel 830 includes a number of overlay types to control the map view 811. Such manipulable layers include a map type panel 831 which allows the user to select static overlays, such as a satellite view or street map view 832, instrument flight rules (IFR) charts, visual flight rules (VFR) charts, or fuel maps.

In addition to static overlays, the map view includes temporally synchronized overlays that map on a pixel-by-pixel basis according to a central clock, including a fire display, weather layers, a planned mission layer, and an ATC layer. Temporal layers may be manipulated within the map display to show past activity, present activity, and predicted future activity, as desired. A TACFI-RS layer panel 833 allows the user to select among display types 834 for the fire display. For example, a display type may depict the fire position and intensity as determined by data from the current time period only, a second display type combines current fire data with previous fire position data, and a third display type projects fire data into the future accounting for projected conditions or projected effects of planned retardant drops, or predicts areas that will burn out, i.e., areas that were burning that are no longer burning. Another available layer is symbology indicating the quality of sensor data, i.e., how recently a pixel was imaged and whether sensing conditions were suboptimal. Another layer may show pixels that are unknown, i.e., areas that prior data indicated were burning, but no current data is available.

A weather layer panel 835 allows the user to select a wind layer and or a satellite imagery layer showing cloud cover or precipitation 836. A miscellaneous panel 837 allows the user to display additional layers 838, such as a layer showing manmade structures, fuel coverage, or other relevant map layers. An air traffic control (ATC) layer (not shown) uses a combination of automatic dependent surveillance-broadcast (ADS-B) data received from the Federal Aviation Administration (FAA), tracking of receivers on assets in theater, GPS-based positions for assets in-theater, and telemetry data from manned and unmanned aircraft in-theater.

A missions panel 840 allows the user to select missions to be displayed. Missions may be sorted according to time of launch, completion status, or mission type, as selected by the user. Shown here, the user has selected primary missions, including fire mapping and retardant drop missions 841, and in this case, a primary container 860 is displayed containing a retardant drop area 861 indicating where drop missions are being conducted, and a mapping area 862 showing the location of fire mapping missions. A message panel 843 includes a text display 844 showing text, instant, or SMS messages between an identified asset and the user.

The mission layer generated by the app allows real-time mission monitoring and control by the command user. When a mission is displayed, the planned track is displayed on the map view, along with a representation of the asset at it executes the mission. As the asset moves along the planned route, the actual track is overlaid on the planned track, and the user can see the asset deviate from the plan in near-real time. The messaging function allows the command user to communicate with the asset, e.g., to make inquiries about deviations from the planned route, convey traffic warnings, suggest route changes for better effectiveness, etc. For retardant drop missions, the planned drop footprint may be compared to the projected actual drop footprint as the retardant is dropped, allowing for rapid assessment of mission success. For mapping missions, the planned track/actual track display can show gaps in planned coverage as they emerge, allowing the command user to order rerouting to cover missed areas. Post-mission, the planned track/actual track display may be captured and used for debriefing purposes. Flight crews may also use the mission view displayed on their asset application to monitor their mission progress and make corrections to achieve the planned tracks where necessary.

A deconfliction panel 846 includes a warning message display 847 alerting the user of a potential collision or interference among assets operating in-theater, that may require user action, e.g., an aircraft is within acceptable distance tolerances from another aircraft, or a secondary asset is approaching the primary container. In some embodiments, an overlay is displayed that depicts assets as they execute their planned mission profiles in the form of an actual track/predicted track display. As the asset moves along the planned track, the predicted track is consumed by the moving asset symbol. By use of the predicted track display, a user may anticipate future traffic conflicts and adjust the timing or ground track of a given mission for deconfliction purposes. The CNC App may also provide an automatic warning if tracks are predicted to conflict. The command user can relay deconfliction or traffic avoidance instructions to assets directly to the asset NCS, which may then command flight profile changes through the HUD.

A temporal display control panel 850 includes a control button 851 to alternately advance or halt the display and also allow the display to rewind and fast-forward. In the play mode, the display shows the fire and firefighting operation as they evolve over time, while in the halt mode, the display can be frozen at a specific time 852, and the state of the operation at the selected time is displayed on the panel. Past, present and future times may be selected on the timeline, allowing the user to view fire and mission history, and current status, as well as a predictive view of future fire evolution and future planned mission ground tracks. The panel also includes a speed control 853 to select among a menu of playback speeds. A time scale control 854 allows the user to select among time intervals to display on the time scale 855, such as 15 minutes, 5 minutes, 30 minutes, etc. By manipulating the timeline bar 856, the user can select a specific time for the temporal display across the range of time displayed on the time scale.

The temporal display control panel 850 also includes a number of command buttons 857 that facilitate command-and-control activities by allowing the user to manipulate the map and overlays, as required. A traffic command button allows the user to select a traffic view showing aerial assets active in the domain. An outline command button shows overlays in outline format to improve visibility of underlying map features. A center button centers the map at a location selected by the user. A bulk fire button reverts the fire display to a bulk depiction, which shows the fire position as determined by data from the current time period. The age of the data showing such fire coverage is known as staleness and is displayed by activation of a staleness command button, which when activated displays a transparency gradient wherein older data is depicted as more transparent. An intensity button displays a raw view of the thermal imagery with no estimation of fire position, and a quality button activates a display of estimated confidence in a given fire position. Finally, a warning function is included so that the application automatically alerts the user if the fire breaches a retardant line or other set trigger position.

### Dynamic Mission Planning

The command-and-control function works in tandem with the mission planning function to execute an ongoing firefighting operation. In part, close coordination between the command-and-control and MP applications is made possible through the use of the common rasterized map display that allows users of both apps to maintain situational awareness regarding the evolution of the fire, and locations and activities of assets in-theater. For example, the mission planner can anticipate a mapping mission requirement for a specific group of pixels/geographic area based on near-real time sensing data, the planned mission coverage overlay, and in-theater traffic data available on the map view. Concurrently, the command user can use the ATGS to recognize the same need, and can order the planned mission to be executed or modified based command priorities accessible through the CNC App. The command user may indicate the desired retardant drop on the map display by using a mission ordering tool, such as a target path line tool, a pixel selection tool, a rectangular area tool, etc. When a retardant footprint is drawn and entered, the MP App is notified, and the mission planner can then build out the requested route. Similarly, the command user has available a mapping tool that specifies a coverage area for a mapping mission to be planned. Tools for SAR missions and cargo/resupply missions are also available, e.g., the command user may use a SAR ordering tool to designate a search area for ground or airborne assets and submit the planning request to the MP App.

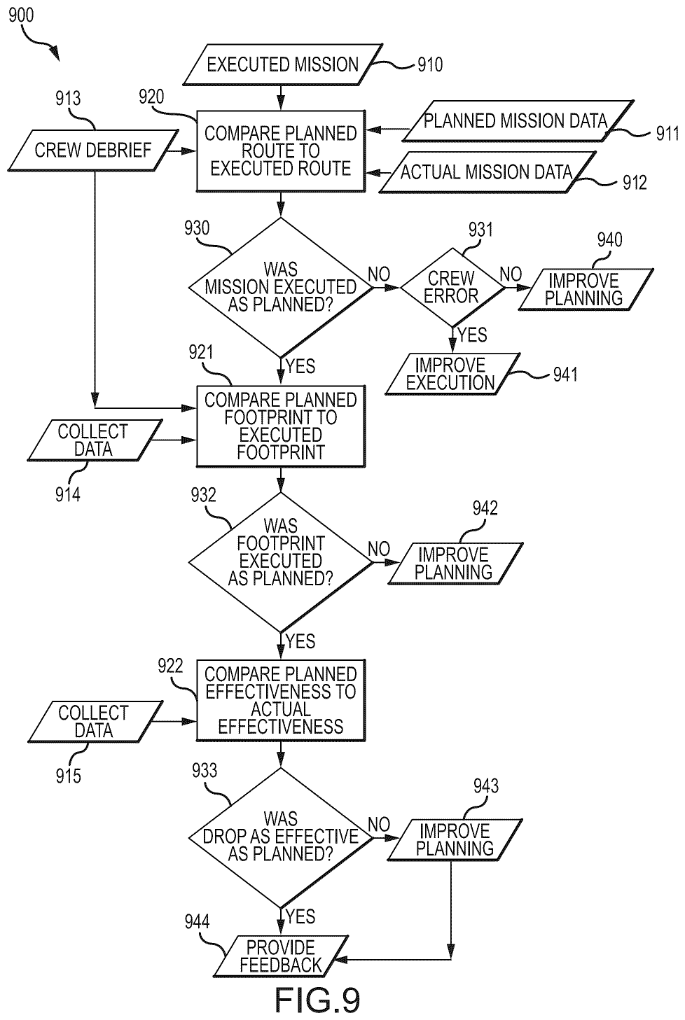

As a further example, the command function can use the common map display to gauge mission effectiveness in conjunction with the mission planning function. With reference to FIG. 9 is depicted a block diagram 900 showing an exemplary dynamic planning process as used in embodiments of the disclosed invention. A tanker executes a planned air drop mission 910, and mission planning information 911 and flight information 912 from the drop is made available to the command user through the ATGS. The command user may use the flight information to assess the difference between the planned drop route and the executed drop route, for example, by manipulating the time display to the past to show the planned drop route and moving to the drop time to see the actual route flown. Further, the command function may receive feedback from a crew debrief 913 to analyze the execution of the drop, adherence to the mission plan, and beneficial or problematic aspects of the mission plan, e.g., as planned the route allowed inadequate clearance with terrain, the retardant load was inadequate to achieve the planned coverage level, etc. Such information and analysis provide the command user insight into whether the mission was flown as planned 930, and if not, whether the deficiency is attributable to the crew 931. It also allows the command user to better judge the effectiveness of the planning function, e.g., if a mission was not flown as planned, the mission's effect on the fire is less attributable to planning and more attributable to execution. This layer of inquiry may result in recommended changes to the planning function 940, or recommended improvements to crew execution 941. Other factors may also be investigated, such as whether the particular asset, or asset type flying the mission was effective.

If the mission was flown as planned, the next level of inquiry concerns whether the actual retardant footprint, on a pixel-by-pixel basis, conformed to the planned retardant footprint 921. To make such a comparison, the command user may use the time display to view the planned drop footprint and compare it to the estimated actual footprint. The app calculates the estimated actual footprint by recording the route flown by the asset and using ballistic modeling to estimate the ground coverage. Alternatively, the command user may order the planning and execution of a new mapping mission 914 to image the footprint of the drop and/or adjacent burning areas to assess the effects of the retardant. Along with crew debrief, such analysis allows the command function to assess how closely the actual footprint of the drop matched the planned footprint 932, which informs the effectiveness of the planned route, and may lead to planning improvements 942. For example, if the calculated retardant trajectory differed from the actual trajectory, the CCRP model could be updated for conditions to improve model predictions.

If the planned footprint and actual footprint are sufficiently matched, the next stage of inquiry is to determine whether the drop had the expected effect on the fire 922. For example, actual fire movement may be mapped 915 and compared to projected fire movement post retardant drop. Projected movement is available through the MP Display or ATGS by selecting a future display time and observing the predicted fire movement based on planned missions. Such effectiveness may be a function of the type of retardant used, footprint placement, planned coverage levels, or other planned factor. If the effectiveness was not as expected 933, the planning function may adjust various aspects of future planned missions 943 to achieve the expected impact on the fire. Mission effectiveness information may then be provided to the mission planning function and crews 944 to improve planning and execution going forward. Because of the use of a shared rasterized map, the disclosed invention allows users to establish a feedback loop to improve firefighting operations throughout an operation.

### Navigation Command System

The disclosed system also includes a navigation command system (NCS), which is configured to provide full navigation commands and/or symbology to manned and unmanned aerial assets. The NCS includes an onboard guidance and display generator, see FIG. 1, item 145, or similar device, mounted in each participating aerial asset. The guidance and display generator receives the planned route from the command-and-control function, or through the mission planning function as directed by the command function. The guidance and display generator may also include an Aviation Asset version of the CNC App that is capable of generating a limited version of the ATGS through an onboard display device. Once received, the NCS processes the planned drop route and generates flight guidance in the HUD or HDD for the pilot to execute. Interface between the NCS and an asset includes instruction to the pilot through a HUD or HDD system, information conveyed through the Asset ATGS, or through direct autopilot navigation. Operators of manned and unmanned systems may be presented commands through the HUD or HDD or may reference a flight guidance display through the Asset ATGS. Alternatively, the asset autopilot may be connected to the NCS, and the asset will fly the prescribed route and perform the planned retardant drop. Navigation guidance provided through the NCS is coordinated with the CNC application to guarantee separation from other assets and terrain within the domain. NCS receives and accounts for wind information and provides wind-corrected precision guidance for retardant drops, mapping, SAR and cargo missions.

For navigating a retardant drop, the NCS is configured to use one of two modes. A first mode precision navigates the aircraft along the planned drop route, providing heading and climb/descent directions to successively navigate to the initial point, start drop point, stop drop point, and exit point. The NCS provides airspeed commands, retardant drop rate, and start and stop drop timing to ensure the drop is flown as planned. In some embodiments, the NCS may automatically command the start and stop points of the drop. A second NCS mode precision navigates the planned target drop path by using ballistic modeling to calculate a corresponding air route. In such cases, the aircraft will navigate to the initial point, then navigation will proceed according to the NCS calculated route. The NCS will provide heading and climb guidance to fly an air route calculated to provide the planned retardant footprint. The NCS also provides airspeed commands, retardant drop rate, and start and stop drop timing to ensure the drop is flown as planned. As with the first mode, the NCS guidance for the second mode may be automated.

In either mode, the NCS records actual aircraft position, as well as the modeled impact locations of the retardant based on the aircraft position. The estimated footprint is further translated to the map display as a pixel-by-pixel overlay of estimated actual coverage, which is reported to the CNC App and incorporated into mission planning and operations. While the aircraft flies the drop route, the actual aircraft position is relayed back to the CNC App, to accomplish real-time deconfliction with other traffic operating in-theater. Further, the NCS monitors safety conditions along the route, including obstacle clearance, heat plume avoidance, etc. If safety conditions are not met, the NCS will command a go-around instruction for the aircraft to abort the drop route and return to a safe altitude. If required aircraft performance is not available to climb to the exit point or to perform a go-around, the NCS will also instruct the pilot to jettison retardant load, or may automatically jettison the retardant load, to ensure adequate performance.

### Heads-Up Display

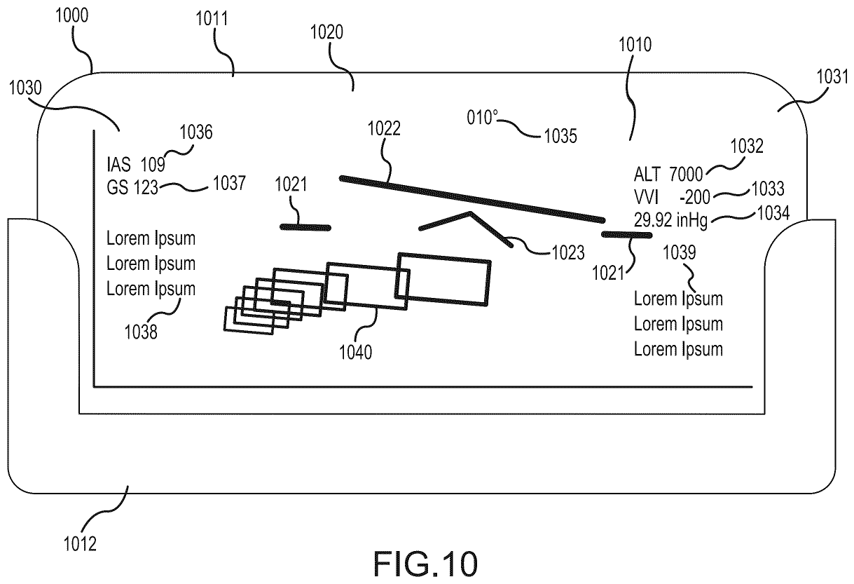

With reference to FIG. 10, an example HUD 1000 for use with embodiments of the NCS is depicted. The HUD projects navigation commands and symbology 1010 onto a transparent screen 1011 located in the line of sight of an asset operator. In manned aircraft, a mounting bracket 1012 secures the HUD to the aircraft instrument panel. The HUD may be generated by equipment mounted on the dash of the aircraft, see FIG. 1, item 140, or otherwise integrated into the flight picture display for an asset, e.g., the control GUI of a UAS. An asset tasked with a retardant drop mission would receive a planned drop route from the ground control station through the CNC App. The onboard guidance and display device would process the planned drop route and generate flight guidance in the HUD for the pilot to execute. The HUD/HDD display includes a main flight guidance panel 1020, and two information panels 1030, 1031 located on either side of the main panel. The main panel includes standard symbology for navigational guidance, as is commonly used in the art. Such symbology includes a horizon indicator 1021, flight director 1022, and aircraft symbol 1023. The information panels 1030, 1031 include relevant flight information, including altitude 1032, vertical velocity 1033, altimeter setting 1034, heading 1035, airspeed 1036, and groundspeed 1037. Windows 1038, 1039 for displaying other relevant information are also included. Different configurations are possible and contemplated. The HUD may also relay deconfliction or traffic avoidance commands as relayed from the command function, such as a climb or descend command relayed through the flight director.

The HUD also includes specialized symbology 1040 for use in firefighting operations. For retardant drop missions, the HUD operates in one of two modes: an ingress/egress mode for guiding the asset to and from the drop route, and a drop mode for executing the retardant drop. When the asset is traveling to the initial point, the ingress/egress mode shows a highway in the sky 1040 display, which is a series of rectangular gates displayed for the pilot to fly through in succession. As the pilot follows the guidance, the asset is directed to the initial point location and altitude. The initial point is located so that the asset only needs minor left or right corrections to drop the retardant along the target path or footprint. Timing information is conveyed by symbology associated with the gates to show that the asset is crossing a gate early, on-time, or late according to the planned route, e.g., the gate switches to red to represent a late crossing, turns green for on-time, and turns yellow for early. The pilot may use such indications to remain on-time or return to proper timing.

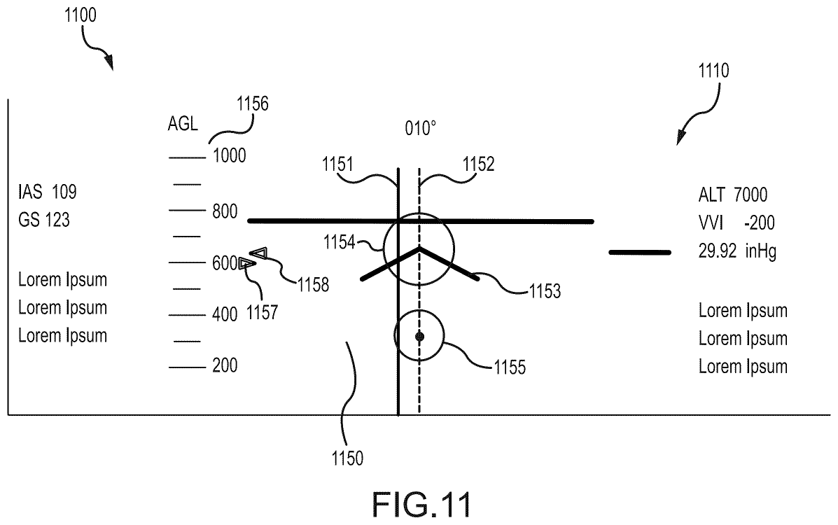

Once the asset passes the initial point, the HUD switches to drop mode. With reference to FIG. 11, an example HUD 1100 for use with embodiments of the NCS is depicted. As depicted, the HUD in drop mode includes navigation commands and symbology 1110 similar to those depicted in FIG. 10. Drop mode includes specialized symbology 1150 for guiding the asset precisely to the wind-corrected start drop location and altitude, then guiding the aircraft along the drop route to the stop drop location and altitude and finally guiding the asset to the route exit point location and altitude.

In some embodiments, the NCS uses a CCRP model to calculate a drop route in real time to place the retardant on the target line or footprint and uses the HUD to guide the asset to the calculated route points. The CCRP model may also calculate and instruct the asset on drop start and stop timing for maximum precision. Drop rates for the retardant may be adjusted continuously during the route to achieve desired coverage levels.

Drop mode symbology includes a centerline 1151 for orienting the asset on the centerline of the planned or CCRP-calculated drop route. A centerline director 1152 guides the asset to align on the centerline, while an aircraft symbol 1153 assists in overall aircraft orientation. A drop indicator 1154 depicts the start drop timing. As the route is flown, the drop indicator moves down and centers on the target indicator 1155, representing that the asset has reached the start drop point and the retardant drop can begin. Once the start drop point has been reached, the HUD uses CCRP modeling to maintain the asset on the target path or footprint. While an asset is proceeding from the start drop point, the CCRP model repeatedly calculates where the retardant being released will impact the ground. As the route progresses, the CCRP updates the calculation using new sensor information, e.g., wind data, airspeed, altitude, etc., and records each calculated impact point. CCRP uses recently calculated impact points to determine a vector for each impact point and compares the vector and position estimate to the desired target path along the ground. Based on this comparison, the NCS adjusts the centerline 1151 to steer the asset, and hence the retardant, left or right, as appropriate, to align the impact point locations and vectors along the target path. When the asset reaches the stop drop point, the retardant drop is ended, and the HUD guides the asset to the exit point in a similar manner.

Drop mode also includes an above ground level (AGL) altimeter 1156 to provide pilots with additional altitude guidance, since retardant drops are typically executed at lower altitudes, and in some cases drop route points may be oriented to AGL altitudes. A carat 1157 appears at the specified drop altitude, in this case 600 ft AGL, while an altitude guide 1158 indicates the asset altitude. When the carat and altitude guide are aligned, the asset is at the specified AGL altitude. Once the asset reached the route exit point, the HUD reverts to ingress/egress mode and guides the asset away from the drop area for deconfliction purposes.

The HUD is configured to generate similar displays to direct mapping missions. For example, the HUD can direct the asset to a mapping start point and altitude, guide the asset along the planned mapping path, and direct the asset to a mapping stop point. The HUD is also configured to direct planned mapping maneuvers, such as banked turns or steep climbs, and command a return to normal flight.

### Computer System

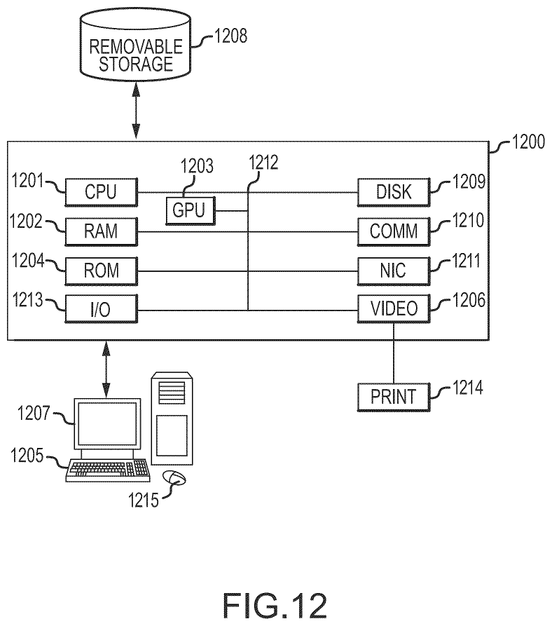

One having skill in the art will recognize that portions of the disclosed invention may be implemented on a specialized computer system, or a general-purpose computer system, such as a personal computer (PC), a server, a laptop computer, a notebook computer, or a handheld or pocket computer. Those skilled in the relevant art will also recognize how to implement the invention using other computer systems or architectures. FIG. 12 is a general block diagram of a general-purpose computer system in which software-implemented processes of the disclosed invention may be embodied. As shown, the system 1200 comprises one or more central processing unit(s) (CPU) or processor(s) 1201 coupled to a random-access memory (RAM) 1202, a read-only memory (ROM) 1204, a keyboard or user interface 1205, a display or video adapter 1206 connected to a display device 1207 (e.g., screen, touchscreen, or monitor), a removable storage device 1208 (e.g., flash drive, floppy disk, cloud storage, etc.), a fixed storage device 1209 (e.g., hard disk, flash memory), a communication (COMM) port(s) or interface(s) 1210, and a network interface card (NIC) or controller 1211 (e.g., Ethernet, wi-fi, cellular, near-field communication, etc.). Some embodiments may include a graphics processing unit(s) (GPU) 1203 to supplement or perform data processing. Although not shown separately, a real time system clock is included with the system 1200, in a conventional manner.

The CPU 1201 comprises a suitable processor for implementing the disclosed invention. In some embodiments, a GPU 1203 may supplement computational tasks as is known in the art. In some embodiments, the processor 1201 may be an Artificial Intelligence (AI) processor, which may be implemented as a Tensor Processing Unit (TPU), or a graphical processor unit, or a custom programmable solution Field-Programmable Gate Array (FPGA). The CPU 1201 communicates with other components of the system via a bi-directional system bus 1212, and any necessary input/output (I/O) controller 1213 circuitry and other “glue” logic. The bus, which includes address lines for addressing system memory, provides data transfer between and among the various components. RAM 1202 serves as the working memory for the CPU 1201. ROM 1204 contains the basic I/O system code (BIOS), which is a set of low-level routines in ROM that application programs and the operating systems can use to interact with the hardware, including reading characters from the keyboard, outputting characters to printers 1214, etc.

Mass storage devices 1208, 1209 provide persistent storage on fixed and removable media, such as magnetic, optical, or magnetic-optical storage systems, flash memory, cloud servers, or any other available mass storage technology. The mass storage may be shared on a network, or it may be a dedicated mass storage. As further shown in FIG. 12, fixed storage 1209 stores a body of program and data for directing operation of the computer system, including an operating system, user application programs, driver, and other support files, as well as other data files of all sorts. Typically, the fixed storage 1209 serves as the main data storage for the system.

In operation, program logic (including that which implements methodology of the disclosed invention described herein) is loaded from the removable storage 1208 or fixed storage 1209 into the main (RAM) memory 1202, for execution by the CPU 1201. During operation of the program logic, the system 1200 accepts user input from a keyboard and pointing device 1215, as well as speech-based input from a voice recognition system (not shown). The user interface 1205 permits selection of application programs, entry of keyboard-based input or data, and selection and manipulation of individual data objects displayed on the screen, touchscreen, or display device 1207. Likewise, the pointing device 1215, such as a mouse, track pad, track ball, pen device, or a digit in the case of a touchscreen, permits selection and manipulation of objects on the display device. In this manner, these input devices support manual user input for any process running on the system.

The computer system 1200 displays text and/or graphic images and other data on the display device 1207, or may output to audio speakers, vibrating motor, LED lights, etc. The video adapter 1206, which is interposed between the display 1207 and the system bus, drives the display device 1207. The video adapter 1206, which includes video memory accessible to the CPU 1201, provides circuitry that converts pixel data stored in the video memory to a raster signal suitable for use by a display monitor. A hard copy of the displayed information, or other information within the system 1200, may be obtained from the printer 1214, or other output device.

The system itself communicates with other devices (e.g., other computers, other networks) via the NIC 1211 connected to a network (e.g., Ethernet network, wi-fi, near field communication network, etc.). The system 1200 may also communicate with local occasionally connected devices (e.g., serial cable-linked devices) via the COMM interface 1210, which may include a serial port, a Universal Serial Bus (USB) interface, or the like. Devices that will be commonly connected locally to the interface 1210 include desktop computers, laptop computers, handheld computers, etc.

The system may be implemented through various wireless networks and their associated communication devices. Such networks may include mainframe computers, or servers, such as a gateway computer or application server which may have access to a database. A gateway computer serves as a point of entry into each network and may be coupled to another network by means of a communications link. The gateway may also be directly or indirectly coupled to one or more devices using a communications link or may be coupled to a storage device such as a data repository or database.

In light of the above-mentioned advantages and the technical advancements provided by the disclosed methods and systems, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described methods and systems for identifying and managing natural disaster incidents, some of which may be accomplished through Artificial Intelligence (AI) models. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the disclosed invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the disclosed invention is in no way limited to implementation in any specific programming language, or for any specific operating system or environment. Accordingly, the disclosure of the disclosed invention is intended to be illustrative, but not limiting, of the scope of the invention.

What is claimed is:

1. A system for control of a firefighting operation, the system comprising:
a ground control center, including a command terminal having a processor, a database, and a display, wherein the ground control center manages a plurality of assets including a manned aircraft, an unmanned aerial system, or a ground vehicle;
a communications network allowing communications among the ground control center and each of the plurality of assets;
a mission planning software application (MP App) for generating a mission planning display, wherein the MP display is used to generate a new mission plan to be executed by an available asset; and
a command-and-control software application (CNC App) hosted on the command terminal, wherein the CNC App generates an Air to Ground Supervisor (ATGS) display, and wherein the ATGS display is used to direct the available asset to execute the new mission plan.

2. The system for control of a firefighting operation of claim 1, the ground control center further comprising one or more secondary terminals, including a mission planning terminal hosting the MP App, and a situational awareness terminal hosting a version of the CNC App configured for use by an emergency manager.

3. The system for control of a firefighting operation of claim 1, the communications network including a satellite communications network, a cellular network, an instant messaging network, or a mesh network.

4. The system for control of a firefighting operation of claim 1, wherein the MP Display and the ATGS display are oriented to a rasterized map display of a geographic area containing a fire incident.

5. The system for control of a firefighting operation of claim 1, the MP App further comprising:
access to fire mapping data for tracking the location and evolution of a fire incident, an asset database for storing data about the plurality of assets; a standard mission database for storing standard mission profiles; a ballistic model for calculating a trajectory of a cargo drop; a planned mission database for storing a plurality of existing mission plans; and a set of conditions inputs including weather data, geographic data, fuels data, and a clock.

6. The system for control of a firefighting operation of claim 5, wherein the MP App uses the planned mission database to alert a user if one of the plurality of existing mission plans conflicts with the new mission plan.

7. The system for control of a firefighting operation of claim 5, wherein the MP App uses the ballistic model to calculate an air route for dropping a fire retardant on one of: a target path along the ground, or one or more selected pixels of the geographic area.

8. The system for control of a firefighting operation of claim 1, the CNC App further comprising: access to fire mapping data for tracking the location and evolution of a fire, access to mission planning data from the MP App for displaying planned missions; access to air traffic data for tracking aircraft operating in an air traffic control area; a mission execution database for displaying a ground track of the available asset; a ballistic model for calculating a trajectory of a cargo drop; and a set of conditions inputs including weather data, geographic data, fuel data, and a clock.

9. The system for control of a firefighting operation of claim 8, wherein the ATGS display includes a timeline controller for depicting the operation at a selected time, including a selected past time, and a selected future time showing a predicted state of the operation.

10. The system for control of a firefighting operation of claim 8, wherein the CNC App uses the ground track, mission planning data, and the ballistic model to calculate an estimated footprint for a fire retardant drop for comparison to a planned footprint for the fire retardant drop.

11. A computer-implemented method for planning a firefighting operation, comprising:
determining an objective of a new mission using a rasterized map display of a geographic area, a fire display, an asset database for storing data about a plurality of firefighting assets, and a planned mission database for storing one or more planned mission ground tracks, wherein the fire display and the one or more planned mission ground tracks are oriented to the rasterized map display on a pixel-by-pixel basis;
assessing a mission environment using a set of conditions for a domain containing the geographic area;
designing a route for the new mission using the mission environment, wherein an available asset is tasked to transit to an initial point, to accomplish the objective, and to transit to an exit point, and wherein the route is depicted on the rasterized map display as a new mission ground track; and
deconflicting the route by comparing the new mission ground track to the one or more planned mission ground tracks.

12. The computer-implemented method for planning a firefighting operation of claim 11, wherein the objective includes one or more of the following: dropping a fire retardant on a target path along the ground, or on one or more selected pixels of geographic area; mapping one or more selected pixels of geographic area; searching for personnel within one or more selected pixels of the geographic area; or transporting a cargo from a depot location to a second location.

13. The computer-implemented method for planning a firefighting operation of claim 11, wherein the rasterized map display includes a timeline controller for depicting the domain at a selected time, including a selected past time, and a selected future time showing a predicted state of the domain.

14. The computer-implemented method for planning a firefighting operation of claim 11, the designing step further comprising routing the available asset to an airspace container for accomplishing the objective, the airspace container having a set geographic area and a set altitude block.

15. The computer-implemented method for planning a firefighting operation of claim 11, the designing step further comprising selecting a footprint for a retardant drop, and using the footprint and a ballistic model to calculate an air route for the retardant drop.

16. The computer-implemented method for planning a firefighting operation of claim 11, the determining step further comprising receiving input from a command-and-control software application, wherein the command-and-control application is oriented to the rasterized map display.

17. A computer-implemented method for assessing a mission, comprising:
determining whether the mission was executed by an asset according to a mission plan, comprising comparing a planned drop route for the mission to an actual drop route flown by the asset, using flight data for the mission, planning data for the mission, and debrief data from the crew of the asset;
determining whether an estimated footprint for the actual drop route matches a planned footprint, comprising: calculating the estimated footprint using a ballistic model and the actual drop route, and comparing the estimated footprint to the planned footprint;
determining whether the estimated footprint achieved an objective of the mission, comprising mapping an actual evolution of a fire, using a predictive map display to observe a projected evolution of the fire, and comparing the actual evolution to the projected evolution.

18. The computer-implemented method for assessing a mission of claim 17, wherein the ballistic model is a continuously computed release point model.

19. The computer-implemented method for assessing a mission of claim 17, further comprising orienting the mission, the mission plan, the planned drop route, the actual drop route, the estimated footprint, the planned footprint, the actual evolution of the fire, and the projected evolution of the fire to a rasterized map display of a domain.

20. The computer-implemented method for assessing a mission of claim 17, further comprising using a command-and-control software application, a mission planning software application, and an asset software application, wherein each software application is oriented to a rasterized map display of a geographic area.
